(19) United States
(12) Patent Application Publication
(10) Pub. No.: US 2013/0126644 A1
(43) Pub. Date: May 23, 2013

(54) Threaded Injector Mount

(71) Applicant: Jeremy Popovich, Brooklyn, MI (US)

(72) Inventor: Jeremy Popovich, Brooklyn, MI (US)

(21) Appl. No.: 13/301,914

(22) Filed: Nov. 22, 2011

(51) Int. Cl. B05B 1/30; F16L 19/03; F16L 19/02

(52) U.S. Cl. 239/569; 285/386; 285/354

(57) ABSTRACT

A system for mounting an injector to an exhaust conduit in an exhaust treatment system includes a boss having an externally threaded surface. The boss is adapted to be fixed to the exhaust conduit. A retention member is adapted to be coupled to the injector housing to transfer an axial load to the housing. An internally threaded nut includes a flange engaging the retention member. The nut threadingly engages with the boss to clamp the housing of the injector to the boss as the nut is rotated.

### FIELD

The present disclosure generally relates to an exhaust treatment system, and more particularly to a simplified injector mounting system including threaded coupling.

### BACKGROUND

In the automotive industry, injectors have been included in exhaust treatment systems, particularly in diesel exhaust gas aftertreatment systems for injecting a fluid such as a suitable fuel, oxygenator or reductant to threat the exhaust gas. One known system for mounting such injectors includes a plurality of bolt studs that extend from an exhaust pipe as part of a bolted flange-type connection for the injector. Another existing mounting system includes a V-band clamp arrangement. While such mounting systems may be suitable for their intended purpose, it may be beneficial to provide a simplified and improved mount.

### SUMMARY

This section provides a general summary of the disclosure, and is not a comprehensive disclosure of its full scope or all of its features.

A system for mounting an injector to an exhaust conduit in an exhaust treatment system includes a boss having an externally threaded surface. The boss is adapted to be fixed to the exhaust conduit. A retention member is adapted to be coupled to the injector housing to transfer an axial load to the housing. An internally threaded nut includes a flange engaging the retention member. The nut threadingly engages with the boss to clamp the housing of the injector to the boss as the nut is rotated.

An injector assembly for injecting a fluid into an exhaust conduit of an exhaust treatment system includes an injector housing having an orifice. A valve member is positioned within the housing and is moveable to allow and cease a flow of fluid through the orifice. A boss including an externally threaded surface is adapted to be fixed to the exhaust conduit. A retention member is adapted to be coupled to the injector housing. An internally threaded nut includes a flange engaging the retention member. The nut is threadingly engaged with the externally threaded surface of the boss. The rotation of the nut axially drives the retention member, which in turn, axially drives the injector housing toward the boss to clamp the injector housing between the nut and the boss.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic depicting an exemplary exhaust treatment system including an injector mount constructed in accordance with the teachings of the present disclosure;

FIG. 2 is an exploded perspective view of an injector assembly including a threaded injector mount; and

FIG. 3 is a fragmentary cross-sectional side view of the injector and injector mount.

Corresponding reference numerals indicate corresponding parts throughout the several views of the drawings.

### DETAILED DESCRIPTION

Example embodiments will now be described more fully with reference to the accompanying drawings.

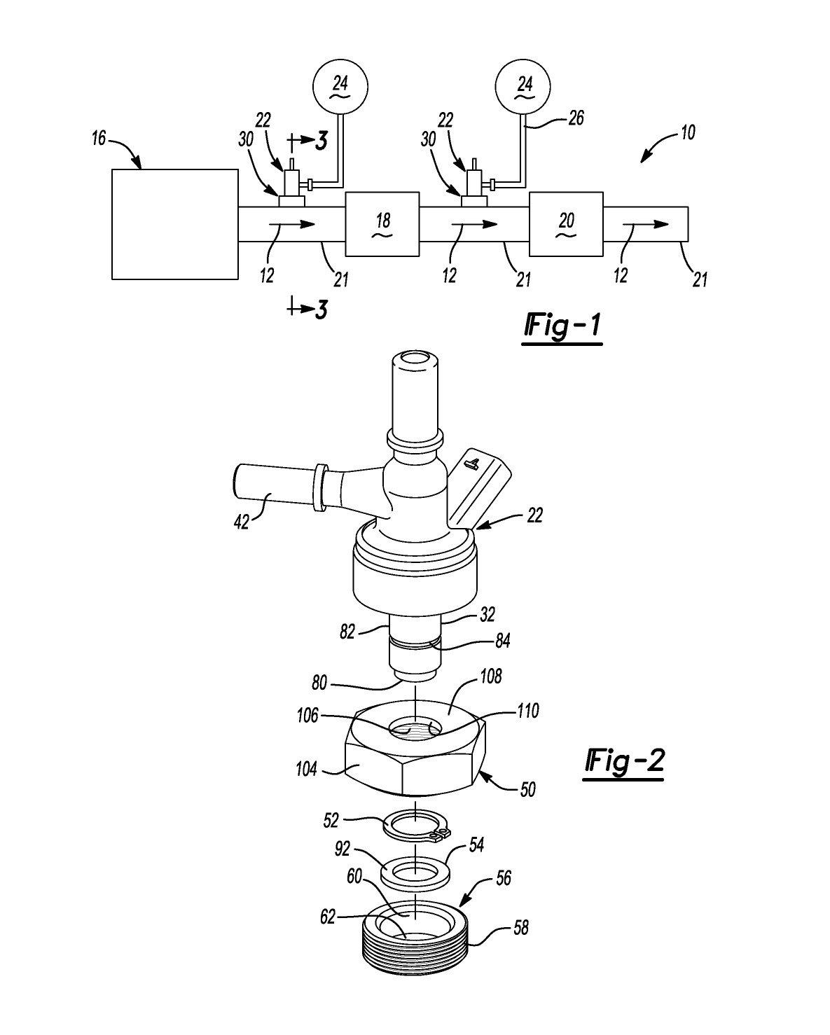

An exhaust gas aftertreatment system 10 is depicted in FIG. 1 for treating the exhaust 12 from an internal combustion engine 16. The exhaust 12 will typically contain oxides of nitrogen (NOₓ) such as nitric oxide (NO) and nitrogen dioxide (NO₂) among others, particulate matter (PM), hydrocarbons, carbon monoxide (CO), and other combustion byproducts. Exhaust aftertreatment system 10 may include one or more components 18 and 20 to assist in the treatment of the exhaust 12, including, for example, any or all of a burner or combustor, a diesel particulate filter (DPF), and a NOₓ reducing device, such as a selective catalytic reduction catalyst (SCR) or a lean NOₓ trap. Components 18 and 20 are connected by exhaust flow conduits 21 that are of any suitable construction, including housings that are integrated with components 18 and 20 and/or exhaust pipes or tubing. An injector 22 may be positioned either upstream or downstream (both examples shown in FIG. 1) of such components to inject a fluid into the exhaust 12, such as, for example, a suitable fuel, an oxygenator, or a reductant. In the illustrated embodiment, each injector 22 is connected to a pressurized supply 24 for the corresponding fluid via a supply conduit 26.

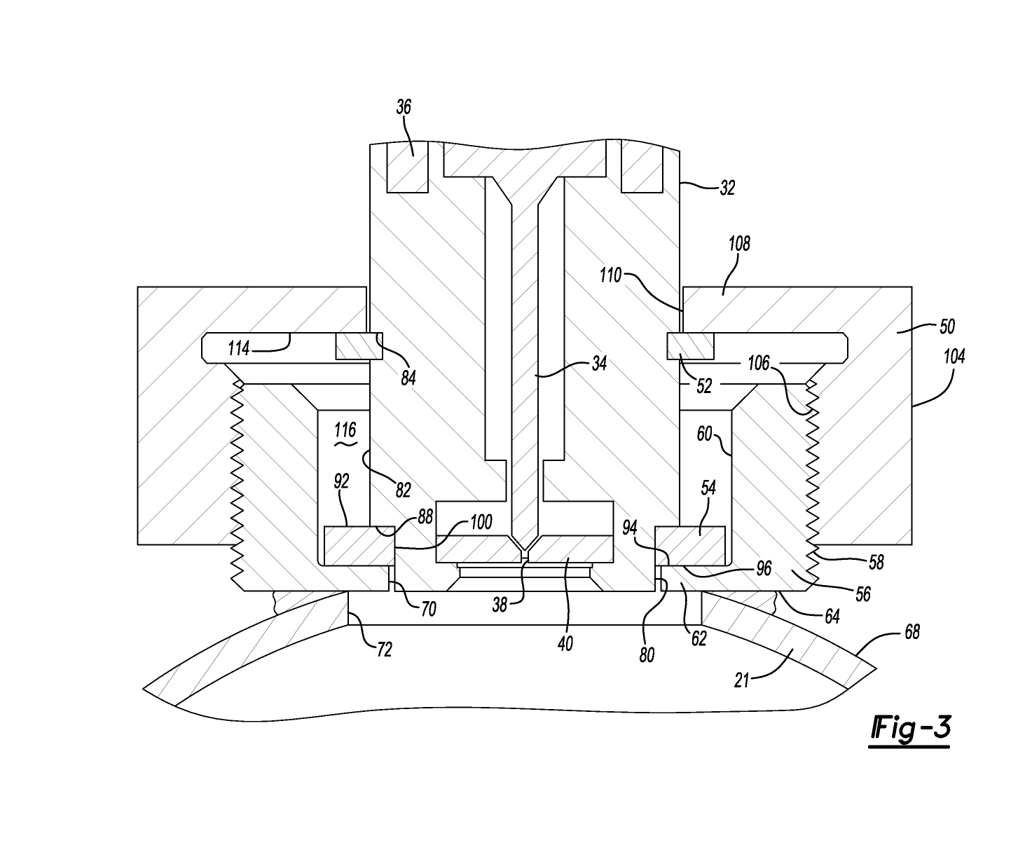

Several different suitable constructions for injector 22 may be used in connection with the mounting system of the present disclosure. One construction is shown in FIGS. 2 and 3 in connection with an injector mounting system 30. Injector 22 includes a housing 32, a valve 34, a molded coil assembly 36 for selectively actuating the valve 34, an orifice/nozzle 38 in the form of an orifice plate 40 for directing an atomized flow of the fluid into exhaust 12, and a supply fitting 42 for connection with the supply conduit 26.

Mounting system 30 includes nut 50, a retaining ring 52, a gasket 54, and a boss 56. Boss 56 is a substantially cylindrical member including an externally threaded portion 58, an internal recess 60 and an internally extending flange 62. A substantially planar surface 64 of boss 56 is fixed to an external surface 68 of exhaust conduit 21. An aperture 70 extends through flange 62. Aperture 70 is aligned with an aperture 72 extending through exhaust conduit 21. At this position, boss 56 is fixed to exhaust conduit 21 using a process such as welding. It should be appreciated that aperture 70 is sized to receive a reduced diameter end portion 80 of housing 32. Housing 32 of injector 22 also includes an enlarged body portion 82 and a ring groove 84. Retaining ring 52 is positioned within retaining ring groove 84. A land 88 is formed on injector housing 32 at the juncture between reduced diameter portion 80 and enlarged diameter portion 82. Land 88 is in contact with a first surface 92 of gasket 54. At the same time, a surface 94 of flange 62 engages an opposite surface 96 of gasket 54. Gasket 54 includes a bore 100 having an inner diameter sized to closely mate and receive reduced diameter portion 80.

Nut 50 includes an externally faceted surface 104 having a hexagonal shape adapted to be engaged by a torquing tool. Nut 50 also includes an internally threaded bore 106 and a radially extending flange 108. An aperture 110 extends through flange 108 having a size slightly larger than an outer diameter of portion 82 of housing 32. A surface 114 of nut 50 engages retaining ring 52. Internal thread 106 mates with external thread 58 of boss 56.

To mount injector 22 to exhaust conduit 21, boss 56 is welded to the conduit after apertures 70 and 72 are aligned with one another. Nut 50 is placed over enlarged portion 82 of injector housing 32. Retaining ring 52 is expanded over enlarged portion 82 and positioned within retaining ring groove 84. Gasket 54 is positioned over reduced diameter end 80 and placed into engagement with land 88. The injector, nut, retaining ring and gasket subassembly is translated until reduced diameter end 80 enters aperture 70 of boss 56. At this time, nut 50 is rotated to threadingly engage internal thread 106 with external thread 58 of boss 56. Nut 50 is torqued until gasket 54 is sufficiently compressed between land 88 and surface 94. Gasket 54 serves the dual purpose of sealing exhaust gasses from a cavity 116 defined by boss 56, nut 50 and injector 22. Gasket 54 also functions to thermally isolate housing 32 of injector 22 from boss 56 and exhaust conduit 21.

In an alternate arrangement, retaining ring 52 may be replaced with a relatively thick stamped clip or washer having a slot to allow the washer to be positioned within retaining ring groove 84 through a transverse movement. Use of mounting system 30 allows simple threaded interconnection between nut 50 and boss 56 without requiring housing 32 of injector 22 to be threaded. It is also contemplated that gasket 54 may be removed to directly engage land 88 with flange surface 94.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An injector mounting system for mounting an injector to an exhaust conduit in an exhaust treatment system, the injector including a housing and an orifice that directs a flow into the exhaust conduit, the injector mounting system comprising:
a boss including a radially extending flange and an externally threaded surface, the boss being adapted to be fixed to the exhaust conduit;
a retention member adapted to be coupled to the injector housing to transfer an axial load to the housing; and
an internally threaded nut including a flange engaging the retention member, the nut being threadingly engaged with the boss and adapted to clamp the injector housing to the boss as the nut is rotated.

2. The injector mounting system of claim 1, further including a gasket engaging the boss flange and spacing the injector housing away from boss.

3. The injector mounting system of claim 2, wherein the nut axially displaces the retention member to compress the gasket between the boss flange and the injector housing.

4. The injector mounting system of claim 3, wherein the nut and boss are sized to remain spaced apart from the injector housing to define a thermally insulating pocket of air between the injector housing and the boss.

5. The injector mounting system of claim 1, wherein the retention member includes a retaining ring.

6. The injector mounting system of claim 1, wherein the nut flange and the boss flange are axially spaced apart from each other.

7. The injector mounting system of claim 1, wherein the boss flange includes an aperture adapted to receive a reduced diameter end of the injector housing.

8. An injector assembly for injecting a fluid into an exhaust conduit of an exhaust treatment system, the injector assembly comprising:
an injector housing including an orifice;
a valve member positioned within the housing and being moveable to allow and cease a flow of fluid through the orifice;
a boss including an externally threaded surface, the boss being adapted to be fixed to the exhaust conduit;
a retention member adapted to be coupled to the injector housing; and
an internally threaded nut engaging the retention member, the nut being threadingly engaged with the externally threaded surface of the boss, wherein the rotation of the nut axially drives the retention member, which in turn, axially drives the injector housing toward the boss to clamp the injector housing between the nut and the boss.

9. The injector assembly of claim 8, wherein the injector housing is substantially cylindrical and includes a groove in receipt of the retention member.

10. The injector assembly of claim 9, wherein the boss includes an aperture in receipt of a reduced diameter portion of the injector housing.

11. The injector assembly of claim 10, wherein the injector housing includes a radially extending land reacting the clamping load.

12. The injector assembly of claim 11, wherein the boss includes a radially extending flange reacting a load transferred through the land.

13. The injector assembly of claim 12, further including a gasket sandwiched between the land and the boss flange to thermally isolate the injector housing from the boss.

14. The injector assembly of claim 13, wherein the retention member includes a retaining ring.

15. The injector assembly of claim 8, wherein the nut includes a radially extending flange engaging the retention member.

16. The injector assembly of claim 15, wherein the nut flange and the boss flange are axially spaced apart from each other.
